(19) United States
(12) Patent Application Publication
(10) Pub. No.: US 2024/0007900 A1
(43) Pub. Date: Jan. 4, 2024

(54) DCI SIZE LIMIT AND DROPPING RULE FOR REDUCED CAPABILITY UE

(71) Applicant: QUALCOMM Incorporated, San Diego, CA (US)

(72) Inventors: Yuwei Ren, Beijing (CN); Huilin Xu, Temecula, CA (US)

(21) Appl. No.: 18/252,768

(22) PCT Filed: Jan. 9, 2021
(86) PCT No.: PCT/CN2021/070989

§ 371 Date: May 12, 2023

(51) Int. Cl. H04W 28/06; H04W 72/232; H04W 72/56

(52) U.S. Cl. CPC H04W 28/06; H04W 72/232; H04W 72/56

(57) ABSTRACT

Systems and method for providing downlink control information (DCI) sizes prioritization rules to enable a wireless network to monitor and decode a number of DCI sizes without exceeding a DCI sizes budget of a UE are disclosed. In embodiments, a UE monitors for a downlink control information (DCI) message having one of a number of different formats and one of a number of different sizes. The UE is configured with a DCI sizes budget indicating a number of different DCI sizes that the UE is configured to decode. The UE applies a DCI sizes prioritization rule to generate a prioritized set of DCI sizes. The prioritized set of DCI sizes includes a number of DCI sizes to be monitored, which is less than or equal to the DCI sizes budget. The UE decodes the DCI message based on the prioritized set of DCI sizes.

### BACKGROUND

### Field

Aspects of the present disclosure relate generally to wireless communication systems, and more particularly, to providing downlink control information (DCI) sizes prioritization rules.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes monitoring, by a user equipment (UE), at least one physical downlink control channel (PDCCH) transmission for a downlink control information (DCI) message having one of a number of different formats and one of a number of different sizes. The UE is configured with a DCI sizes budget indicating a number of different DCI sizes that the UE is configured to decode. The monitoring includes applying a DCI sizes prioritization rule to generate a prioritized set of DCI sizes. The prioritized set of DCI sizes includes a number of DCI sizes to be monitored, and the number of DCI sizes to be monitored is less than or equal to the DCI sizes budget. The method also includes decoding the DCI message based on the prioritized set of DCI sizes.

In an additional aspect of the disclosure, an apparatus configured for wireless communication is disclosed. The apparatus includes at least one processor, and a memory coupled to the processor. The processor is configured to monitor, by a UE, at least one PDCCH transmission for a DCI message having one of a number of different formats and one of a number of different sizes. The UE is configured with a DCI sizes budget indicating a number of different DCI sizes that the UE is configured to decode. The configuration of the at least one processor to monitor the at least one PDCCH transmission for the DCI message includes configuration of the at least one processor to apply a DCI sizes prioritization rule to generate a prioritized set of DCI sizes. The prioritized set of DCI sizes includes a number of DCI sizes to be monitored, and the number of DCI sizes to be monitored is less than or equal to the DCI sizes budget. The processor is further configured to decode the DCI message based on the prioritized set of DCI sizes

In an additional aspect of the disclosure, an apparatus configured for wireless communication includes means for monitoring, by a UE, at least one PDCCH transmission for a DCI message having one of a number of different formats and one of a number of different sizes. The UE is configured with a DCI sizes budget indicating a number of different DCI sizes that the UE is configured to decode. The means for monitoring include means for applying a DCI sizes prioritization rule to generate a prioritized set of DCI sizes. The prioritized set of DCI sizes includes a number of DCI sizes to be monitored, and the number of DCI sizes to be monitored is less than or equal to the DCI sizes budget. The apparatus further includes means for decoding the DCI message based on the prioritized set of DCI sizes.

In an additional aspect of the disclosure, a non-transitory computer-readable medium having program code recorded thereon. The program code further includes code to monitor, by a UE, at least one PDCCH transmission for a DCI message having one of a number of different formats and one of a number of different sizes. The UE is configured with a DCI sizes budget indicating a number of different DCI sizes that the UE is configured to decode. The program code for causing the computer to monitor the at least one PDCCH transmission for the DCI message includes program code for causing the computer to apply a DCI sizes prioritization rule to generate a prioritized set of DCI sizes. The prioritized set of DCI sizes includes a number of DCI sizes to be monitored, and the number of DCI sizes to be monitored is less than or equal to the DCI sizes budget. The program code further includes code to decode the DCI message based on the prioritized set of DCI sizes.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIG. 3 is a diagram illustrating a downlink control information (DCI) transmission scheme from a base station to a UE according to one or more aspects of the present disclosure.

FIGS. 4A and 4B are diagrams illustrating a DCI size alignment procedure performed during determination of DCI formats according to one or more aspects of the present disclosure.

FIG. 5 is a block diagram illustrating example blocks executed to implement one aspect of the present disclosure.

FIG. 6 is a block diagram conceptually illustrating a design of a user equipment (UE) configured according to some embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜0.99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

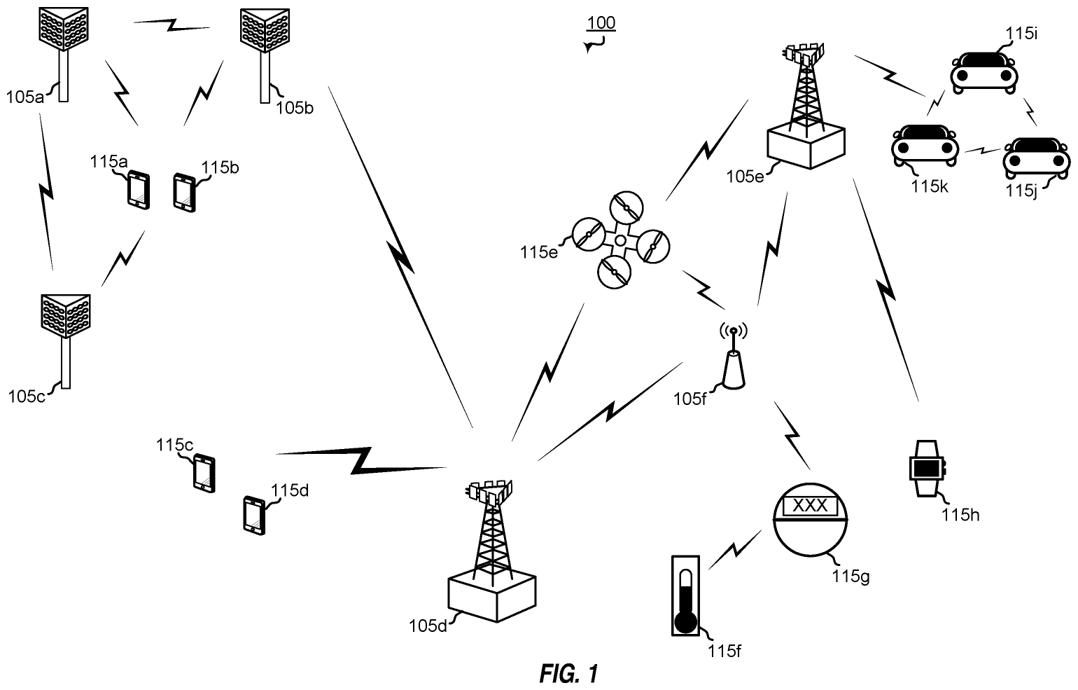

FIG. 1 is a block diagram illustrating an example of a wireless communications system 100 that supports providing downlink control information (DCI) sizes prioritization rules to enable the wireless communications system to monitor and decode a number of DCI sizes without exceeding a DCI sizes budget of a UE in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or NR network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be referred to as forward link transmissions while uplink transmissions may also be referred to as reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and, therefore, provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone (UE 115a), a personal digital assistant (PDA), a wearable device (UE 115d), a tablet computer, a laptop computer (UE 115g), or a personal computer. In some examples, a UE 115 may also refer to a wireless local loop (WLL) station, an Internet-of-things (IoT) device, an Internet-of-everything (IoE) device, an MTC device, or the like, which may be implemented in various articles such as appliances, vehicles (UE 115e and UE 115f), meters (UE 115b and UE 115c), or the like.

Some UEs 115, such as MTC or IoT devices, may be low cost or low complexity devices, and may provide for automated communication between machines (e.g., via machine-to-machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In other cases, UEs 115 may be designed to support critical functions (e.g., mission critical functions), and a wireless communications system 100 may be configured to provide ultra-reliable communications for these functions.

In certain cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 may facilitate the scheduling of resources for D2D communications. In other cases, D2D communications may be carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

Wireless communications system 100 may include operations by different network operating entities (e.g., network operators), in which each network operator may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In various implementations, wireless communications system 100 may use both licensed and unlicensed radio frequency spectrum bands. For example, wireless communications system 100 may employ license assisted access (LAA), LTE-unlicensed (LTE-U) radio access technology, or NR technology in an unlicensed band (NR-U), such as the 5 GHz ISM band. In some cases, UE 115 and base station 105 of the wireless communications system 100 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available.

A CCA may include an energy detection procedure to determine whether there are any other active transmissions on the shared channel. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include message detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In certain implementations, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In additional cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot, while in other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier,” as may be used herein, refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a predefined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In certain instances, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum, such as NR-shared spectrum (NR-SS)). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In additional cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

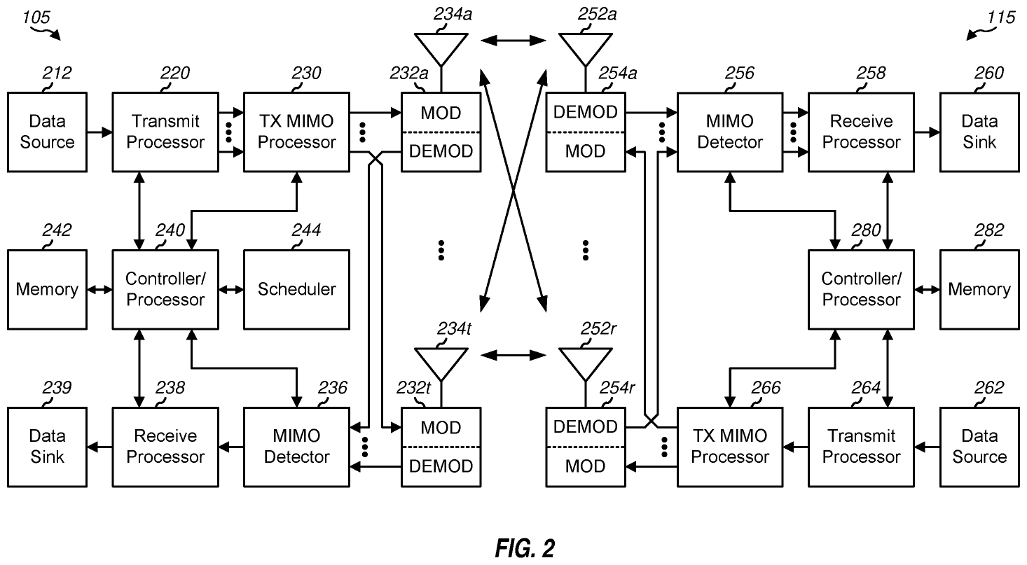

FIG. 2 shows a block diagram of a design of a base station 105 and a UE 115, which may be one of the base station and one of the UEs in FIG. 1. At base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

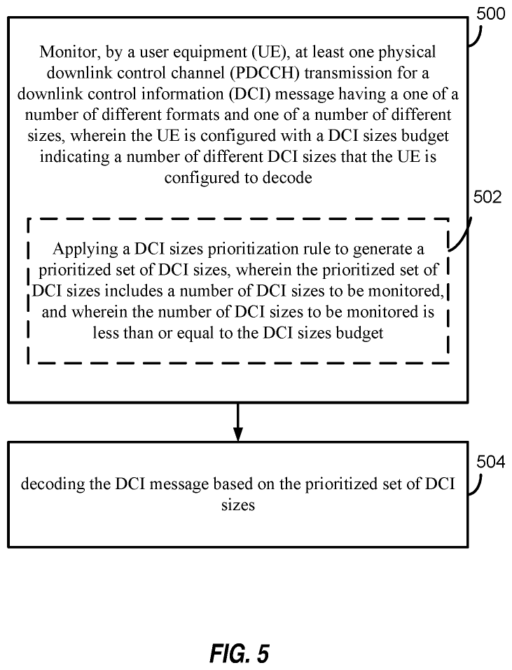

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIG. 5, and/or other processes for the techniques described herein. The memories 242 and 282 may store data and program codes for the base station 105 and the UE 115, respectively. A scheduler 244 may schedule UEs for data transmission on the downlink and/or uplink.

Various aspects of the present disclosure are directed to systems and methods for providing downlink control information (DCI) sizes prioritization rules to enable a wireless network to monitor and decode a number of DCI sizes without exceeding a DCI sizes budget of a UE. In particular, aspects of the present disclosure provide techniques and systems for defining and/or applying DCI sizes prioritization rules that rank or prioritize different potential DCI sizes, and for dropping DCI sizes until the DCI sizes budget of the UE is met, and for performing blind decoding using the resulting number of DCI sizes. In some embodiments, the DCI sizes prioritization rules may be applied to generate a prioritized set of DCI sizes that includes a number of DCI sizes less than or equal to the DCI sizes budget of the UE, and the UE may perform blind decoding using the prioritized set of DCI sizes. Various aspects of DCI sizes prioritization rules will be discussed in the explanation that follows.

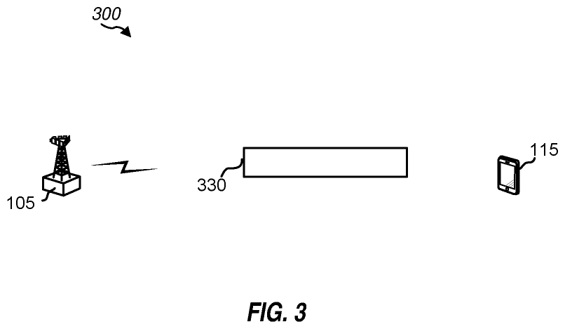

In wireless communication systems, the PDCCH may carry DCI, which may include scheduling information for the uplink or downlink data channels and other control information for a UE or a group of UEs. In these wireless communication systems, a UE may decode the DCI to obtain the control information. FIG. 3 is a diagram illustrating a DCI transmission from a base station to a UE. In the particular example of wireless communication system 300 illustrated in FIG. 3, base station 105 may transmit DCI message 330 to UE 115. However, DCI message 330 may have one of a number of different formats, and one of a number of different sizes. In addition, initially, UE 115 may have very limited information or details about the control channel structure of the PDCCH carrying DCI message 330, and does not know the exact size of format of DCI message 330. Typically, UE 115 may blind decode DCI message 330 by monitoring for and/or trying the many different potential formats and sizes for DCI message 330. That is, UE 115 may try to blind decode DCI message 330 using the different possible formats and sizes.

Indeed, in some implementations, the only thing a UE knows is a particular range, also called search space, that possibly carries the PDCCH that include the DCI message. Within this search space, the UE performs blind decoding for a set of PDCCH candidates, and attempts to blind decode the DCI message using different types of parameters (e.g., format, size, radio network temporary identifier (RNTI), etc.) based on trial and error for each of those PDCCH candidates. The two types of search spaces that are used are the UE specific search space (USS), which is monitored by an individual UE, and the common search space (CSS), which is commonly monitored by a group of UEs.

Table 1 below illustrates an example of different possible DCI formats and their use.

TABLE 1
DCI Formats

| DCI Format | Usage |
|---|---|
| Format 0_0 | Fallback DCI format for scheduling of PUSCH. |
| Format 0_1 | Non-fallback DCI format for scheduling of PUSCH. |
| Format 1_0 | Fallback DCI format for scheduling of PDSCH. |
| Format 1_1 | Non-fallback DCI format for scheduling of PDSCH. |
| Format 2_0 | Notifying a group of UEs of the slot format. |
| Format 2_1 | Notifying a group of UEs of the PRB(s) and OFDM |
| | symbol(s) where UE may assume no transmission is |
| | intended for the UE. |
| Format 2_2 | Transmission of a group of power control commands |
| | for PUCCH and PUSCH. |
| Format 2_3 | Transmission of a group of SRS requests and power |
| | control commands for SRS transmissions. |

As will be appreciated, the complexity of a UE is related to the number of DCI sizes that the UE may be expected to monitor for, or try when blind decoding, for the various formats. The more DCI sizes the UE has to try, the more complexity is added. In 5G NR implementations, this issue is addressed by limiting the number of DCI sizes that a UE may be required to monitor per serving cell. This limitation may be referred to herein as a DCI sizes budget. Thus, herein, a DCI sizes budget may refer to a number or limit of different DCI sizes that a UE may be configured to monitor. For example, a DCI size budget of four may indicate that a UE is to monitor for four different sizes of DCI formats.

In particular, in 5G NR, a UE is configured to monitor PDCCH candidates for up to 4 sizes of DCI formats that include up to 3 sizes of DCI formats with CRC scrambled by cell C-RNTI per serving cell. The UE counts a number of sizes for DCI formats per serving cell based on a number of configured PDCCH candidates in respective search space sets for the corresponding active downlink bandwidth part (BWP). As such, in 5G NR, a maximum number of DCI sizes is defined.

As noted above, there may be up to 3 sizes of DCI formats with CRC scrambled by cell C-RNTI due to the following reasons. One reason is that fallback downlink DCI (e.g., DCI format 1_0) and fallback uplink DCI (e.g., DCI format 0_0) have the same size. Another reason is that neither non-fallback downlink DCI (DCI format 1_1) nor non-fallback uplink DCI (DCI format 0_1) is required to have the same size as another DCI. In addition, group-common DCI may have a different size than other DCI messages. It is noted that although C-RNTI is discussed, it should be appreciated that C-RNTI, CS-RNTI, or MCS-C-RNTI may be used.

Additionally, the UE may monitor one DCI size using RNTIs for special purposes (such as SFI-RNTI and INT-RNTI). In this case, the DCI scrambled with a RNTI used for a special purpose is less time-critical than a UE scrambled with C-RNTI for the UE to decode.

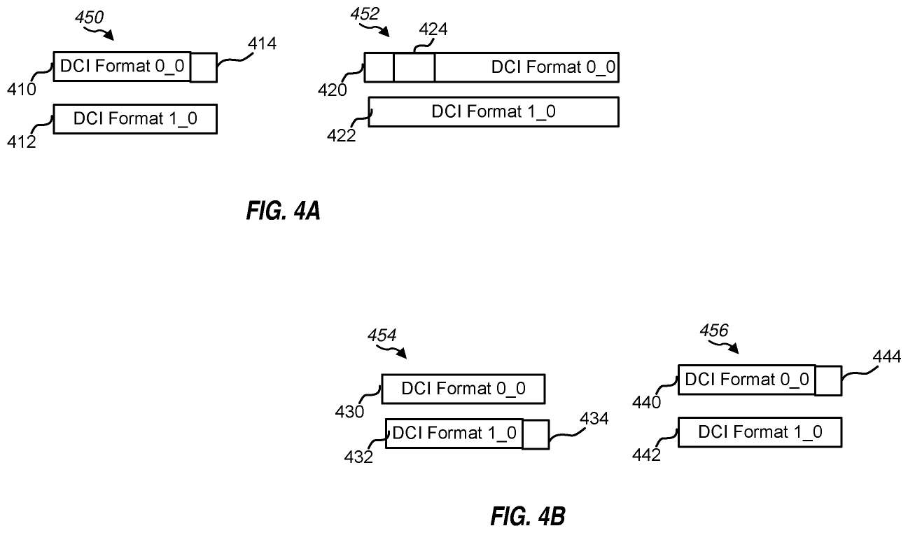

In implementations, due to the constraint of the DCI size budget, the sizes of some DCI formats may be aligned by padding, truncation, and/or determining the frequency domain resource assignment field differently, which may cause DCI formats having different sizes. FIGS. 4A and 4B illustrate an example in which DCI formats may have different sizes. In particular, FIGS. 4A and 4B are diagrams illustrating a DCI size alignment procedure performed during determination of DCI formats. In the example illustrated in FIG. 4A, it is shown that in CSS, DCI format 0_0 and 1_0 determine the length of the DCI format. Specifically, as shown at 450, if the size of DCI format 0_0 410 is determined to be smaller than the size of DCI format 1_0 412, then the size of DCI format 0_0 410 may be padded with padding 414 to equal the size of DCI format 1_0 412.

In another example, at 452, DCI format 0_0 420 may be determined to include frequency domain resource assignment 424. In addition, the size of DCI format 0_0 420 may be determined to be larger than the size of DCI format 1_0 422. In this case, the size of frequency domain resource assignment 424 may be reduced to render the size of DCI format 0_0 420 to be equal to the size of DCI format 1_0 422.

In the example illustrated in FIG. 4B, it is shown that in USS, DCI format 0_0 and 1_0 determine the length of the DCI format. Specifically, as shown at 454, if the size of DCI format 0_0 430 is determined to be larger than the size of DCI format 1_0 432, then the size of DCI format 1_0 432 may be padded with padding 434 to equal the size of DCI format 1_0 432. In another example, at 456, if the size of DCI format 0_0 440 is determined to be smaller than the size of DCI format 1_0 442, then the size of DCI format 0_0 440 may be padded with padding 444 to equal the size of DCI format 1_0 442.

In addition to the determination of the DCI formats 0_0 and 1_0 in CSS, and DCI formats 0_0 and 1_0 in USS, a determination of the DCI formats 0_1 and 1_1 may be made, to include determining their sizes. As a result, if DCI formats 0_0 and 1_0 occur in different bandwidths in CSS and USS, a total of four different DCI size would be present (one for each DCI size in CSS, one in USS, one for DCI format 0_1, and one for DCI format 1_1).

The problems arising from the DCI sizes budget limitation of a UE are particularly significant in a reduced capability (RedCap) UEs. A RedCap UE may refer to devices that may have low complexity, reduced capabilities (e.g., fewer antennas, smaller antenna size, smaller bandwidth etc.), and/or a compact form factor, such as sensors and/or wearables, when compared with a traditional UE. As such, a RedCap UE may not be able to handle the complexity caused by having to blind decode a large number of DCI sizes, or may simply have a low DCI sizes budget (e.g., lower than 4 sizes as in typical 5G NR UEs). In addition, a typical UE may also benefit from a lower complexity as it the UE may be able to lower its power and/or data consumption if the UE does not have to blind decode a large number of DCI sizes.

In particular, in a RedCap UE, the blind detection limit may be reduced by reducing the DCI size budget without increasing the PDCCH blocking probability. This is because for each PDCCH candidate, the blind detection number N, is the same as the number of different DCI sizes (e.g., one for uplink non-fallback DCI and one for downlink non-fallback DCI, etc.). However, it should be noted that the number of DCI sizes that a UE must monitor for a PDCCH candidate is determined by the DCI format of the PDCCH candidate according to the search space configuration associated with the PDCCH.

Various aspects of the present disclosure are directed to systems and methods for providing DCI sizes prioritization rules to enable a wireless network to reduce the number of DCI sizes to be monitored. In aspects, the number of DCI sizes to be monitored by a UE may be reduced to a number equal to or less than four, which is the number of sizes in current implementations of 5G NR systems, and/or equal to or less than the DCI sizes budget of the UE. In some aspects, the configuration of the UE to reduce the number of DCI sizes to be monitored may be configured per slot, as opposed across all slots, to avoid restriction of PDCCH configuration. As such, the prioritized set of DCI sizes to be monitored for one slot may include a number of DCI sizes that is different than the number of DCI sizes in a prioritized set of DCI sizes to be monitored for a different slot. In aspects, the rules may be based on a predefined priority or may be dynamically configured in accordance with system requirements and/or configuration.

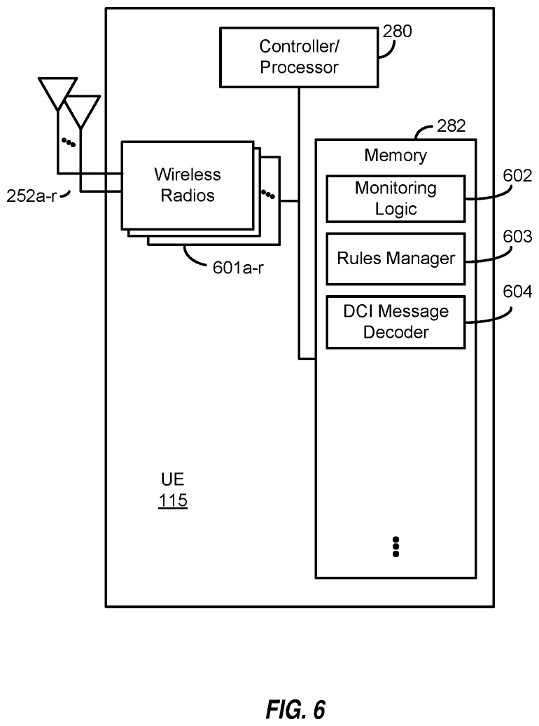

FIG. 5 is a block diagram illustrating example blocks executed to implement one aspect of the present disclosure. The example blocks will also be described with respect to UE 115 as illustrated in FIG. 6. FIG. 6 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 601a-r and antennas 252a-r. Wireless radios 601a-r includes various components and hardware, as illustrated in FIG. 2 for UE 115, including modulator/demodulators 254a-r, MIMO detector 256, receive processor 258, transmit processor 264, and TX MIMO processor 266.

At block 500, a UE monitors at least one PDCCH transmission for a DCI message having one of a number of different formats and one of a number of different sizes. In order to implement the functionality for such operations, UE 115, under control of controller/processor 280, executes monitoring logic 602, stored in memory 282. The functionality implemented through the execution environment of monitoring logic 602 allows for UE 115 to perform DCI message monitoring operations according to the various aspects herein.

In aspects, UE 115 may be configured with a DCI sizes budget. The DCI sizes budget may indicate a number of different DCI sizes that the UE is configured to decode. For example, UE 115 may have a DCI sizes budget of N. In this case, UE 115 may monitor the PDCCH candidates and may blind decode up to N different sizes of DCI messages. In some aspects, the DCI sizes budget of UE 115 may be defined by configuration (e.g., network reconfiguration, dynamic configuration via signaling) or may be defined by the UE's capabilities (e.g., UE 115 may be a RedCap UE with limited capabilities). In some aspects, the DCI sizes budget N may be equal to or less than four.

At block 502, the UE, as part of monitoring at least one PDCCH transmission for a DCI message, applies a DCI sizes prioritization rule to generate a prioritized set of DCI sizes. In order to implement the functionality for such operations, UE 115, under control of controller/processor 280, executes rules manager 603, stored in memory 282. The functionality implemented through the execution environment of rules manager 603 allows for UE 115 to perform DCI sizes prioritization operations according to the various aspects herein.

In some aspects, the DCI sizes prioritization rule may be applied to include DCI sizes to the prioritized set of DCI sizes (or to drop DCI sizes from the prioritized set of DCI sizes) if PDCCH configuration in a slot indicates that the DCI sizes budget of the UE has been exceeded. For example, the DCI sizes budget of UE 115 may be 3. In this case, for a first slot, the PDCCH configuration may indicate that in the first slot, the number of different sizes of the DCI messages in the PDCCH candidates in the slot is greater than 3. In this case, the DCI sizes prioritization rule may be applied to ensure that UE 115 may only have to monitor for a number of DCI sizes that are less than or equal to 3, namely the DCI sizes budget of UE 115.

In some embodiments, the application of the DCI sizes prioritization rule includes prioritizing and/or ranking the different DCI sizes based on the DCI sizes prioritization rule, and then including no more than the N highest prioritized DCI sizes into the prioritized set of DCI sizes. For example, PDCCH configuration in the first slot may indicate that there are 4 DCI sizes in the first slot, and UE 115 may have a DCI sizes budget of 3. In this case, the 4 DCI sizes may be prioritized and/or ranked in accordance with the DCI sizes prioritization rule. Then, UE 115 may perform blind decoding using the top 3 DCI sizes, and may exclude or drop the bottom DCI size.

In some embodiments, after prioritizing and/or ranking the different DCI sizes based on the DCI sizes prioritization rule, the lowest prioritized DCI sizes may be removed until there are no more than N DCI sizes in the prioritized set of DCI sizes. For example, PDCCH configuration in the first slot may indicate that there are 5 DCI sizes in the first slot, and UE 115 may have a DCI sizes budget of 3. In this case, the 5 DCI sizes may be prioritized and/or ranked in accordance with the DCI sizes prioritization rule. Then, the two lowest ranked DCI sizes may be dropped or excluded, and UE 115 may perform blind decoding using the remaining three DCI sizes.

In some embodiments, applying the DCI sizes prioritization rule may include including the N highest prioritized DCI sizes into the prioritized set of DCI sizes, where N may be a number less than the DCI sizes budget of the UE. In these aspects, the DCI sizes may be limited to the number N, which may be less than the DCI sizes budget. In aspects, the number N may be configured per slot, such that in a first slot N may be different than for a second slot.

In some embodiments, the DCI sizes prioritization rule may be signaled to the UE by a network entity (e.g., a base station). In some embodiments, the UE may signal to a base station (e.g., serving base station 105 in FIG. 3) that the UE is a RedCap UE. In this case, the base station may provide the DCI sizes prioritization rule to the UE, or may signal the UE to use predefined rules (e.g., DCI sizes prioritization rules stored in the UE).

In some embodiments, the DCI sizes prioritization rule may be based on the priority of the DCI formats (e.g., DCI formats 0_0, 0_1, 0_2, 1_2, 1_0, 1_1, 2_0, 2_1, 2_3, etc.). For example, in some implementations the DCI sizes associated with a lowest priority DCI format may be dropped until the UE DCI sizes budget is met, or until a number lower than the DCI sizes budget of the UE is reached.

In one particular implementation, a fallback DCI format (e.g., DCI format 0_0 and DCI format 1_0) may be ranked or prioritized lower than a non-fallback DCI format (e.g., DCI format 0_1 and DCI format 1_1). In this case, a DCI size associated with a fallback DCI format may be dropped (e.g., dropped from the prioritized set of DCI sizes, or dropped from being used in blind decoding) before a DCI size associated with a non-fallback DCI format. In aspects, this rule may provide a benefit as non-fallback DCI may include useful and/or necessary information for control in downlink and uplink communications. In some embodiments, as a minimum, the prioritized set of DCI sizes may include a DCI size associated with a fallback DCI format. In some aspects, this fallback/non-fallback rule may include further granularity and may define that a downlink DCI format be prioritized higher than an uplink format, or that an uplink DCI format be prioritized higher than a downlink format. For example, a DCI size associated with a fallback DCI format may be dropped (e.g., dropped from the prioritized set of DCI sizes, or dropped from being used in blind decoding) before a DCI size associated with a non-fallback DCI format, but in this case a DCI size associated with a non-fallback uplink DCI format (e.g., DCI format 0_1) may be dropped before a DCI size associated with a non-fallback downlink DCI format (e.g., DCI format 1_1). In yet other examples, a DCI size associated with a fallback uplink DCI format (e.g., DCI format 0_0) may be dropped before a DCI size associated with a fallback downlink DCI format (e.g., DCI format 1_0).

In some aspects, the priority of a DCI format may be specified by specific conditions or scenarios. For example, in an uplink dominant configuration, a determination may be made that uplink DCI is more important than downlink DCI. In this case, a DCI size associated with a downlink DCI format may be dropped before a DCI size associated with an uplink DCI format. Similarly, in a downlink dominant configuration, a determination may be made that downlink DCI is more important than uplink DCI. In this case, a DCI size associated with an uplink DCI format may be dropped before a DCI size associated with a downlink DCI format.

In a particular example, UE 115 may be a RedCap UE having a DCI sizes budget of 4. In a first slot, there may be 3 DCI sizes, an these may include DCI sizes associated with a DCI having a DCI format 0_0/1_0 in CSS, DCI format 0-0/1-0 in USS, DCI format 0_1, and DCI format 1_0. In this case, based on the fallback/non-fallback rule described above, the DCI size associated with DCI format 0_1 (e.g., a fallback uplink DCI format) may be dropped. In this case, the prioritized set of DCI sizes may include DCI sizes associated with a DCI having a DCI format 0_0/1_0 in CSS, DCI format 0-0/1-0 in USS, and DCI format 1_0, thereby meeting the DCI sizes budget of UE 115. UE 115 may perform decoding (e.g., blind decoding) of the DCI message using the prioritized set of DCI sizes which excludes the DCI size associated with DCI format 0_1 (e.g., a fallback uplink DCI format).

In some embodiments, the DCI sizes prioritization rule may be based on the priority of the search space set to which the PDCCH candidate with the DCI message belongs. In these cases, DCI sizes associated with PDCCH candidates in the lowest priority search space set may be dropped until the DCI sizes budget of the UE is reached, or until a number lower than the DCI sizes budget of the UE is reached.

In aspects, the priority of the search space may be determined based on the identifier (ID) of the search space. As noted above, the UE performs blind decoding for a set of PDCCH candidates based on search space sets. There are two search space set types, a CSS set, which is commonly monitored by a group of UEs, and a USS set, which is monitored by an individual UE. In some implementations, a UE may be configured with up to 40 search space sets, where each set has an ID of 0-39. Generally, the lower the ID the lower the priority of the associated search space set. In accordance with this, in aspects, a first DCI size associated with a PDCCH in the search space set having a first ID may be prioritized higher than a second DCI size associated with a PDCCH in a search space sets with a second ID lower than the first ID. In this case, the second DCI size may be dropped (e.g., dropped from the prioritized set of DCI sizes, or dropped from being used in blind decoding) before the first DCI size. In some aspects, the entire search space set having a lowest ID (e.g., any DCI size associated with a PDCCH in the search space set) may be dropped.

It should be noted that, in some implementations, a CSS set with ID of 0 is a special CSS set. In some aspects, a DCI size associated with a PDCCH in the CSS set 0 may be prioritized highest than DCI sizes associated with PDCCHs in search space sets with a higher ID. In some aspects, the inclusion of a CSS set may mean that the DCI sizes budget may be satisfied in the slot.

In aspects, the priority of the search space may be determined based on the type of the search space. Table 2 below shows different types of search spaces and their use, as well as information on the RNTI.

TABLE 1
Search Space Types

| Type | Search Space | RNTI | Use Case |
|---|---|---|---|
| Type0-PDCCH | Common | SI-RNTI for RMSI on a primary cell | SIB Decoding |
| Type0A-PDCCH | Common | SI-RNTI on a primary cell | SIB Decoding |
| Type1-PDCCH | Common | RA-RNTI, TC-RNTI, C-RNTI on a | Msg2, Msg4 decoding |
| | | primary cell | in RACH |
| Type2-PDCCH | Common | P-RNTI on a primary cell | Paging Decoding |
| Type3-PDCCH | Common | INT-RNTI, SFI-RNTI, TPC-PUSCH-RNTI, | |
| | | TPC-PUCCH-RNTI, TPC-SRS-RNTI, | |
| | | C-RNTI, CS-RNTI(s), SP-CSI-RNTI | |
| | UE-Specific | C-RNTI, or CS-RNTI(s), or SP-CSI-RNTI | User specific |
| | | | PDSCH decoding |

In some implementation, the priority of the search space set may follow the order of Table 1 (e.g., Type0 has a higher priority than Type0A, and Type0A has a higher priority than Type1, etc). In this case, DCI sizes associated with PDCCHs in a USS may be removed first. Then, DCI sizes associated with PDCCHs in a CSS Type3 may be removed. Then, DCI sizes associated with PDCCHs in a CSS Type2 may be removed, and so on up the list shown in Table 1 until the DCI sizes budget of the UE is reached, or until a number lower than the DCI sizes budget of the UE is reached.

In some embodiments, the DCI sizes prioritization rule may specify the specific priority of the different types (e.g., Type 0A has higher priority than Type0), and this priority may be used to rank the DCI sizes based on the type of the search space set to which the PDCCH associated with the DCI size belongs. As such, a first DCI size may be associated with a PDCCH in a search space set having a type that is of a first priority. In the same example, a second DCI size may be associated with a PDCCH in a search space set having a type that is of a second priority lower than the first priority. In this case, the second DCI size may be dropped before the second DCI size. In some implementation, CSS types have a higher priority than USS types.

In some aspects of the present disclosure, the DCI sizes prioritization rule may be based on the priority of a control resource set (CORESET) associated with the PDCCH candidates. In particular, the CORESET ID may be used to determine a priority of the CORESET. In some implementations, a UE may be configured with a number of CORESETs on each BWP associated with a serving cell. Each CORESET may have an ID. In embodiments, the DCI sizes prioritization rule may be configured with a predefined priority order (or rank) for the different CORSET IDs. In this case, applying the DCI sizes prioritization rule may result in the DCI sizes associated with a PDCCH associated to the lowest priority CORESET ID being dropped first. The next lowest priority CORESET ID (or rather the DCI sizes associated with a PDCCH associated to the next lowest priority CORESET ID) may be dropped next. This process may continue until the DCI sizes budget of the UE is reached, or until a number lower than the DCI sizes budget of the UE is reached.

It should be noted that in some implementations a CORESET with ID=0 is a special CORESET. CORESET 0 may be configured by the master information block (MIB) and may be acquired even before higher-layer configurations are provided, e.g., before additional system information or dedicated configuration is provided. In some aspects, a DCI size associated with a PDCCH associated with CORESET 0 may be prioritized highest than DCI sizes associated with PDCCHs associated with CORESETs having a higher ID. As such, DCI size associated with a PDCCH associated with CORESETs having an ID higher than 0 may be dropped before a DCI size associated with a PDCCH associated with CORESET 0. In some aspects, a DCI size associated with a PDCCH associated with CORESET 0 is never dropped.

In some aspects of the present disclosure, the DCI sizes prioritization rule may be based on the size of the DCI message. In this case, the different DCI sizes in the slot may be prioritized based on the actual DCI size. In aspects, a larger size may have a lower priority than a smaller size. For example, a first DCI with a first size may be prioritized higher than a second DCI size of a second size larger than the first size. In this case, the largest DCI size may be dropped first. Then the next largest DCI size may be dropped. This process may continue until the DCI sizes budget of the UE is reached, or until a number lower than the DCI sizes budget of the UE is reached.

In some aspects, a smaller size may have a lower priority than a larger size. For example, a first DCI with a first size may be prioritized higher than a second DCI size of a second size lower than the first size. In this case, the smallest DCI size may be dropped first. Then the next smallest DCI size may be dropped. This process may continue until the DCI sizes budget of the UE is reached, or until a number lower than the DCI sizes budget of the UE is reached.

In some aspects of the present disclosure, the DCI sizes prioritization rule may be based on the RNTI associated with the candidate PDCCH. In this case, the different RNTIs may be prioritized differently. In aspects, the DCI sizes prioritization rule may be configured with a predefined priority order (or rank) for the different RNTIs. For example, in one implementation, a DCI size associated with a C-RNTI PDCCH may be prioritized highest. In this case, DCI sizes associated with PDCCH other than C-RNTI may be dropped before the DCI size associated with a C-RNTI PDCCH.

In some aspects of the present disclosure, the DCI sizes prioritization rule may be based on a DCI type. In this implementations, a DCI may be compact or non-compact. For example, a compact DCI may be a DCI with a small size, or at least smaller than the non-compact DCI. In aspects, a DCI size associated with a compact DCI may be prioritized higher than a DCI size associated with a non-compact DCI. In other aspects, a DCI size associated with a non-compact DCI may be prioritized higher than a DCI size associated with a compact DCI. In some aspects, further granularity may be provided by the DCI sizes prioritization rule to include downlink/uplink type. For example, a DCI size associated with a compact DCI may be dropped before a DCI size associated with a non-compact DCI, but a DCI size associated with a non-compact uplink DCI may be dropped before a DCI size associated with a non-compact downlink DCI. In another example, a DCI size associated with a non-compact downlink DCI may be dropped before a DCI size associated with a non-compact uplink DCI. In yet another example, a DCI size associated with a compact uplink DCI may be dropped before a DCI size associated with a compact downlink DCI. In still another example, a DCI size associated with a compact downlink DCI may be dropped before a DCI size associated with a compact uplink DCI.

It is noted that in aspects of the present disclosure, DCI sizes associated with a PDCCH in a CSS set generally have a higher priority than DCI sizes associated with a PDCCH in a USS set.

At block 504, the UE decodes the DCI message based on the prioritized set of DCI sizes. In order to implement the functionality for such operations, UE 115, under control of controller/processor 280, executes DCI message decoder 604, stored in memory 282. The functionality implemented through the execution environment of DCI message decoder 604 allows for UE 115 to perform DCI message decoding operations according to the various aspects herein. In aspects, decoding the DCI message based on the prioritized set of DCI sizes may include blind decoding the message, as described above, using the DCI sizes in the prioritized set of DCI sizes.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 3-6 may comprise processors, electronics devices, hardware devices, electronics components, logical circuits, memories, software codes, firmware codes, etc., or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication at a user equipment (UE), comprising:
monitoring at least one physical downlink control channel (PDCCH) transmission for a downlink control information (DCI) message having one of a number of different formats and one of a number of different sizes, wherein the UE is configured with a DCI sizes budget indicating a number of different DCI sizes that the UE is configured to decode, wherein the monitoring includes:
applying a DCI sizes prioritization rule to generate a prioritized set of DCI sizes, wherein the prioritized set of DCI sizes includes a number of DCI sizes to be monitored, and wherein the number of DCI sizes to be monitored is less than or equal to the DCI sizes budget; and
decoding the DCI message based on the prioritized set of DCI sizes.

2. The method of claim 1, wherein applying the DCI sizes prioritization rule to generate the prioritized set of DCI sizes:
prioritizing DCI sizes based on the DCI sizes prioritization rule; and
including highest prioritized DCI sizes in the prioritized set of DCI sizes until the number of DCI sizes in the prioritized set of DCI sizes reaches the DCI sizes budget of the UE.

3. The method of claim 1, wherein decoding the DCI based on the prioritized set of DCI sizes includes:
dropping DCI sizes that are excluded from the prioritized set of DCI sizes.

4. The method of claim 1, wherein applying the DCI sizes prioritization rule to generate the prioritized set of DCI sizes is applied to PDCCH configuration for a single slot.

5. The method of claim 1, wherein the DCI sizes budget of the UE is configured for the single slot.

6. The method of claim 1, wherein a number of DCI sizes to be included in the prioritized set of DCI sizes is configured for the single slot, and wherein the number of DCI sizes to be included in the prioritized set of DCI sizes for another slot is different than the number of DCI sizes to be included in the prioritized set of DCI sizes for the single slot.

7. The method of any claim 1, wherein the DCI sizes prioritization rule is based on a priority of a DCI format.

8. The method of claim 7, wherein a non-fallback DCI message is prioritized higher than a fallback DCI message.

9. The method of claim 8, wherein a non-fallback downlink DCI message is prioritized higher than a non-fallback uplink DCI message.

10. The method of claim 7, wherein the priority of the DCI format is based on a configuration of the at least one PDCCH, wherein:
when the configuration of the at least one PDCCH is uplink dominant, an uplink DCI message is prioritized higher than a downlink DCI message; and
when the configuration of the at least one PDCCH is downlink dominant, a downlink DCI message is prioritized higher than an uplink DCI message.

11. The method of claim 1, wherein the DCI sizes prioritization rule is based on a priority of a search space associated with the at least one PDCCH.

12. The method of claim 11, wherein a PDCCH associated with a search space having a lower identification (ID) is prioritized lower than a PDCCH associated with a search space having a higher ID.

13. The method of claim 11, wherein a PDCCH associated with a search space having a first type is prioritized higher than a PDCCH associated with a search space having a second type.

14. The method of claim 1, wherein the DCI sizes prioritization rule is based on a priority of a control resource set (CORESET) identification (ID) associated with the at least one PDCCH.

15. The method of claim 1, wherein the DCI sizes prioritization rule is based on a size of a DCI message to be monitored.

16. The method of claim 15, wherein a DCI message having a first size is prioritized higher than a DCI message having a second size larger than the first size.

17. The method of claim 15, wherein a DCI message having a first size is prioritized higher than a DCI message having a second size smaller than the first size.

18. The method of claim 1, wherein the DCI sizes prioritization rule is based on a radio network temporary identifier (RNTI) associated with the at least one PDCCH.

19. The method of claim 1, wherein the DCI sizes prioritization rule is based on a type of a DCI message to be monitored.

20. The method of claim 19, wherein the type of the DCI message to be monitored is one of: compact and non-compact.

21. (canceled)

22. An apparatus configured for wireless communication, the apparatus comprising:
at least one processor; and
a memory comprising instructions,
wherein the at least one processor is configured to execute the instructions and cause the apparatus to:
monitor at least one physical downlink control channel (PDCCH) transmission for a downlink control information (DCI) message having one of a number of different formats and one of a number of different sizes, wherein the apparatus is configured with a DCI sizes budget indicating a number of different DCI sizes that the apparatus is configured to decode, wherein the configuration of the at least one processor to monitor the at least one PDCCH transmission for the DCI message includes configuration of the at least one processor to:
apply a DCI sizes prioritization rule to generate a prioritized set of DCI sizes, wherein the prioritized set of DCI sizes includes a number of DCI sizes to be monitored, and wherein the number of DCI sizes to be monitored is less than or equal to the DCI sizes budget; and
decode the DCI message based on the prioritized set of DCI sizes.

23. The apparatus of claim 22, wherein the DCI sizes prioritization rule is based on a priority of a DCI format.

24. The apparatus of claim 22, wherein the DCI sizes prioritization rule is based on a priority of a search space associated with the at least one PDCCH.

25. The apparatus of claim 22, wherein the DCI sizes prioritization rule is based on a priority of a control resource set (CORESET) identification (ID) associated with the at least one PDCCH.

26. The apparatus of claim 22, wherein the DCI sizes prioritization rule is based on a size of a DCI message to be monitored.

27. The apparatus of claim 22, wherein the DCI sizes prioritization rule is based on a radio network temporary identifier (RNTI) associated with the at least one PDCCH.

28. The apparatus of claim 22, wherein the DCI sizes prioritization rule is based on a type of a DCI message to be monitored.

29. (canceled)

30. (canceled)

31. A user equipment comprising:
a transceiver;
at least one processor; and
a memory comprising instructions,
wherein the at least one processor is configured to execute the instructions and cause the UE to:
monitor, via the transceiver, at least one physical downlink control channel (PDCCH) transmission for a downlink control information (DCI) message having one of a number of different formats and one of a number of different sizes, wherein the UE is configured with a DCI sizes budget indicating a number of different DCI sizes that the UE is configured to decode, wherein the configuration of the at least one processor to monitor the at least one PDCCH transmission for the DCI message includes configuration of the at least one processor to:
apply a DCI sizes prioritization rule to generate a prioritized set of DCI sizes, wherein the prioritized set of DCI sizes includes a number of DCI sizes to be monitored, and wherein the number of DCI sizes to be monitored is less than or equal to the DCI sizes budget; and
decode the DCI message based on the prioritized set of DCI sizes.
